(19) United States
(12) Patent Application Publication
(10) Pub. No.: US 2006/0055375 A1
(43) Pub. Date: Mar. 16, 2006

(54) Voltage supply circuit and method for starting a circuit arrangement

(76) Inventor: Simone Fabbro, Villach (AT)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/215,400

(22) Filed: Aug. 30, 2005

(30) Foreign Application Priority Data
Aug. 30, 2004 (DE) 10 2004 041920.5

(51) Int. Cl. H02J 7/00

(52) U.S. Cl. 320/132

(57) ABSTRACT

One or more aspects of the present invention pertain to a voltage supply circuit arrangement. In one example, an arrangement comprises a voltage regulator designed to output a regulated voltage, derived from a first supply voltage applied to a supply input. An additional circuit component is also included that has inactive and active operating states, wherein the circuit has a functional action in the active operating state. In the active operating state, a charge store is part of the circuit. In the inactive operating state, the circuit is coupled to the output of the voltage regulator component, where the voltage regulator component is designed to output a charging current to the charge store. In addition, a control circuit is provided which is designed to evaluate an electrical parameter for the charge store. On the basis of the evaluation, the charge store is coupled to the circuit. As a result, the circuit adopts the active operating state.

### REFERENCE TO RELATED APPLICATIONS

This application claims the benefit of the priority date of German application DE 10 2004 041 920.5, filed on Aug. 30, 2004, the contents of which are herein incorporated by reference in their entirety.

### FIELD OF THE INVENTION

One or more aspects of the present invention relate to a voltage supply circuit, and a method for starting up a circuit arrangement.

### BACKGROUND OF THE INVENTION

The desire for a high level of mobility by users makes it necessary for electronic devices, such as mobile radios, PDAs (personal digital assistants), portable computers (e.g., laptops, notebooks) and/or other mobile devices, for example, to be powered by one or more batteries that meet current and/or voltage needs. The users' desire for small, lightweight devices that can be easily carried is leading to a reduction in the size of batteries and hence also in the amount of power available. Accordingly, to extend the life of mobile devices, the devices are often designed to operate in one or more power saving modes.

In a power saving state, circuit elements which are not needed are isolated from the voltage or current supply. This lowers the overall power consumption and extends the life of the battery.

On the other hand, it is necessary for mobile devices to be switched back quickly from power-saving modes to active operating states prior to use. During this phase, a mobile device's switching elements which were previously isolated from the power supply need to be reactivated. Depending on the circuit element(s) in the mobile device, this may require that various capacitors be charged to a certain voltage, inter alia. By way of example, capacitors with a large capacitance have to be charged for supply circuits which supply low voltages with little noise. Active filter circuits within mobile devices also sometimes require ceratin charge stores.

An example is included in EP-A-1 361 664. The bandgap reference circuits illustrated therein control a supply circuit whose output voltage is only slightly below the supply voltage delivered by the battery or the storage battery. In this case, the capacitor required for the supply circuit has a charge applied to it even during the power-saving operating state. However, leakage currents in the capacitor result in a continuous power consumption even during the power-saving state, which means that such a design is not entirely desirable.

Another way of reactivating a mobile device's switching elements that have previously been disconnected involves shortening the charging time for the capacitors in the individual elements to reach the envisaged voltage levels. This is often a problem, however, since low-noise circuit elements are generally designed for relatively small currents, which can significantly prolong the charging time.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present one or more concepts of the invention in a simplified form as a prelude to the more detailed description that is presented later.

One or more aspects of the present invention pertain to an arrangement which provides a rapid charging process for capacitance-based circuits and has a low power consumption during a power-saving operating state. A method for activating from a power-saving operating state to an active operating state for capacitance-based circuits is also disclosed according to one or more aspects of the present invention.

According to one or more aspects of the present invention, an exemplary voltage supply circuit comprises a regulator circuit which can adopt a first and a second operating state. In the second operating state, the regulator circuit is designed to output a regulated voltage derived from a supply voltage. The regulator circuit additionally comprises a supply input for supplying the supply voltage. Furthermore, the arrangement contains a circuit with an inactive operating state and an active operating state, the active operating state providing a functional action of the circuit. A charge store is provided which in the active operating state of the circuit forms part of the circuit for producing the functional action. In the inactive operating state of the circuit or in the first operating state of the regulator circuit, the charge store is coupled to the output of the regulator circuit. In the first operating state, the regulator circuit is designed to output a charging current to the charge store. This means that during the inactive operating state of the circuit the charge store is coupled to the regulator circuit and during the active operating state of the circuit it is coupled to the circuit. Finally, the voltage supply circuit contains a control circuit which is connected to the switch. The control circuit has a sensor for evaluating a parameter for the charge store and, when a particular value of the parameter for the charge store is reached, is designed to couple the charge store to the circuit. As a result, the circuit adopts its active operating state. Preferably, the regulator circuit is in the form of a voltage regulator or in the form of a current regulator for outputting a regulated voltage or current signal.

According to one or more aspects of the present invention, the effect achieved by an exemplary arrangement is that a circuit whose operation requires a charged charge store can arrive at its active operating state very quickly. This is achieved by the regulator circuit, which is suitably designed for the charging process for the charge store. The quantity of charge or the voltage on the charge store which is required for the circuit to operate can be output much more quickly by the regulator circuit, on account of a higher current-carrying capacity, than the circuit with which the charge store is associated.

According to one or more aspects of the present invention, an exemplary voltage supply circuit comprises a charging arrangement and a circuit, with the circuit having an associated charge store. The charging arrangement is also designed to output a first supply voltage and a charging current to an output in a first operating state and to output a second supply current to the output in a second operating state. In the first operating state, the charge store associated with the circuit is connected to the charging arrangement in order to supply the charging current. In the second operating state, the charge store is connected to the circuit in order to operate the circuit.

According to one or more aspects of the present invention, and exemplary arrangement is particularly advantageous when the circuit is designed for small currents. An exemplary circuit which is designed for the charging process and which may be coupled to the charge store has a high current-carrying capacity relative to a circuit in whose operation the charge store is provided.

According to one or more aspects of the present invention, an exemplary method for activating a circuit arrangement, involves applying a large charging current to a charge store in a circuit. However, this charging current is not provided by the circuit, but rather by a second circuit designed for processing large currents. Consequently, the second circuit is not part of the circuit. When a sufficiently high charge has been reached on the charge store, the charge store is coupled to the circuit, and the circuit is put into an active operating state.

One or more aspects of the present invention can be implemented in mobile devices which have a power-saving operating state. In this power-saving operating state, switching elements in the mobile device are isolated from a voltage supply. To change to an active operating state, these switching elements are connected to the voltage supply. It may also be necessary to apply a charge to charge stores. During the activation or startup phase, charge stores to which a charge is to be applied are therefore isolated from their associated circuits in the mobile device and connected to another circuit, which charges them with a large charging current. The charge stores therefore have a large charging current applied to them. Once the necessary voltage across the respective charge store or the necessary charge on the charge store has been amassed, the charge store is isolated from the supply of the charging current and is coupled to the circuit. The circuit is then put into an active operating state.

According to one or more aspects of the present invention, an exemplary method allows a significant reduction in the duration of an activation operation or in the duration of a startup operation. At the same time, the power consumption in a power-saving mode is reduced, since the switching elements and, in particular, also the charge stores which are not required are isolated from a residual power supply (e.g., a battery).

According to one or more aspects of the present invention, an exemplary control circuit comprises a differential amplifier having a first and a second input. The first input is connected to a connection of the charge store. The second input is designed to supply a reference signal. In one example, the differential amplifier is designed to compare the voltage across the charge store with a corresponding reference voltage and, on the basis of the comparison, control a switch for coupling the charge store to the circuit or to the charging circuit. In one example, the control circuit comprises an element for evaluating the charge on the charge store.

According to one or more aspects of the present invention, an exemplary control circuit is coupled to the regulator circuit and/or to the circuit. It is designed to output signals which put one or more circuits connected to it into a desired operating state. This means that the control circuit is able to change the circuit from the inactive operating state to the active operating state, for example. This promotes error-free operation of the circuit, since in a suitable embodiment the control circuit is designed to output an activation signal to the circuit at a time at which the charge store is coupled to the circuit.

According to one or more aspects of the present invention, an exemplary circuit comprises an active filter which is formed with the charge store. In another refinement of the invention, the circuit and its associated charge store are designed to control the regulator circuit in order to output the regulated voltage in the second operating state of the regulator circuit. Preferably, the charge store forms an RC element with a load. In one preferred embodiment, the circuit comprises a bandgap reference circuit. This is coupled to the regulator circuit and is designed for control with the regulator circuit such that the regulator circuit in the second operating state outputs a voltage regulated by the bandgap reference circuit.

According to one or more aspects of the present invention, an exemplary regulator circuit comprises a differential amplifier having a first input, a second input and an output. The first input is coupled to the circuit and the second input is coupled to the output of the regulator circuit. The differential amplifier is thus designed to compare a signal which is output by the circuit with a voltage which can be tapped off at the output of the regulator circuit. Expediently, the circuit is designed to generate a constant and uniform signal. At the same time, the arrangement is thus designed to regulate the regulator circuit.

According to one or more aspects of the present invention, it is expedient in the first operating state of the regulator circuit to couple the charge store to the supply input of the regulator circuit. As a result, the charge store's charging current is particularly high, since it is connected directly to the supply voltage.

According to one or more aspects of the present invention, the regulator circuit and the circuit are in the form of integrated circuits in a semiconductor body. This is particularly expedient when the semiconductor body has further integrated circuits which are supplied by being connected to the output of the regulator circuit. In one example, the charge store is arranged outside of the semiconductor body. This is advantageous when charge stores having a very large capacitance and therefore also a relatively long charging time are provided. Charge stores with a very large capacitance can be produced outside of the semiconductor body so as to save surface area. Inputs and outputs of the regulator circuit are provided by contact pads produced on the surface of the semiconductor body.

According to one or more aspects of the present invention, the control circuit comprises a signal input for disconnection. This signal input is connected to the circuit, with the circuit in the active operating state being designed to output a disconnection signal to the control circuit. This reduces the power consumption of the control circuit, since said control circuit is no longer required during the active operating state.

### BRIEF DESCRIPTION OF THE DRAWINGS

The invention is explained in more detail below wherein reference is made to the following drawings.

FIG. 1 is a schematic block diagram illustrating an exemplary circuit arrangement according to one or more aspects of the present invention.

FIG. 2 is a schematic block diagram illustrating an exemplary circuit arrangement according to one or more aspects of the present invention.

FIG. 3 is a schematic block diagram illustrating an exemplary circuit arrangement according to one or more aspects of the present invention.

FIG. 4 is a schematic block diagram illustrating an exemplary methodology according to one or more aspects of the present invention.

### DETAILED DESCRIPTION OF THE INVENTION

One or more aspects of the present invention will now be described with reference to the drawing figures, wherein like reference numerals are used to refer to like elements throughout. It should be understood that the drawing figures and following descriptions are merely illustrative and that they should not be taken in a limiting sense. In the following description, for purposes of explanation, numerous specific details are set forth in order to provide a thorough understanding of the present invention. It will be evident to one skilled in the art, however, that the present invention may be practiced without these specific details. Thus, it will be appreciated that variations of the illustrated systems and methods apart from those illustrated and described herein may exist and that such variations are deemed as falling within the scope of the present invention and the appended claims.

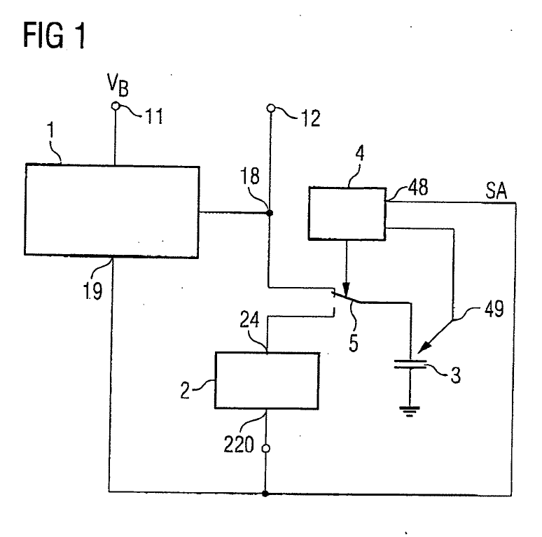

FIG. 1 illustrates a first exemplary embodiment of a circuit arrangement according to one or more aspects of the present invention. The exemplary circuit arrangement can be used in mobile devices equipped with a limited power supply (e.g., a battery), such as, for example, a mobile telephone, cd player, MP3 player, PDA, etc.

Such mobile devices frequently have a voltage regulator which takes a supply voltage applied to an input of a device and derives therefrom a second voltage, which is required for operating individual switching elements in the device. In many cases, the supply voltage is provided by the battery in the mobile device. The voltage regulators, which are sometimes referred to as “low dropout regulators” (LDOs), are distinguished by a particularly small voltage difference between and input and an output. At the same time, they allow connected circuits to be supplied with a stable voltage almost up until the supply voltage applied to the input reaches the value of the regulated output voltage. Regulator circuits can be disconnected provided that the circuits connected to them do not require a supply voltage.

In mobile telephones equipped for the mobile radio standard GSM, for example, a transmission path is active only during a very short time period. During the rest of the time period, it is therefore possible to disconnect part of the transmission path. This reduces the power consumption significantly and thus increases the service life of the storage battery. If a transmission is again required, the individual circuits and also the voltage regulators need to be supplied with the necessary voltage. At the same time, it may be necessary to charge capacitors, for example, for active filters and/or for voltage reference circuits.

Circuits which are designed for processing very low voltages or small currents while requiring a charged capacitor for operation generally require a long time for their activation. One or more aspects of the present invention provide a technique for speeding up the charging process and thus of shortening the activation time for a circuit which is in a power-saving operating state.

In this regard, the voltage regulator circuit 1 illustrated in FIG. 1 has its output connected to a capacitor 3 via a switch 5. In the present exemplary embodiment, the other connection of the capacitor 3 is at ground potential. The output of the voltage regulator circuit 1 simultaneously also forms the regulated supply output 12 for the voltage supply for other switching elements (not shown). In addition, a second circuit 2 is provided which requires the charged capacitor 3 for active operation.

The switch 5 is therefore in a form such that in one switching state it connects the output of the voltage regulator 1 to the capacitor 3, and in a second switching state it connects an input 24 of the circuit 2 to the capacitor 3.

Furthermore, a control circuit 4 is provided which comprises a sensor 49. The sensor 49 ascertains the voltage value across the capacitor 3 or the charge stored on the capacitor 3. On the basis of this charge, the control circuit 4 generates a signal which it outputs to the switch 5. This signal switches the switch 5 from the first switching state in which the capacitor 3 is connected to node 18 to the second switching state where the capacitor 3 is operatively coupled to input 24.

At the same time, the output 48 of the control circuit 4 generates a further signal SA which is supplied to an input 220 of the circuit 2 and also to an input 19 of the circuit 1. The signal SA switches the circuit 2 to an active operating state. The signal is output by the control circuit 4 at a time at which the capacitor 3 is already connected to the input 24 of the circuit 2. This mitigates errors when changing over to an active operating state for the circuit 2. In addition, the signal SA is applied to the input 19 of the voltage regulator 1. When the signal SA is applied, the voltage regulator 1 switches to the first operating state and then outputs a regulated voltage at the node 18 and at the output 12.

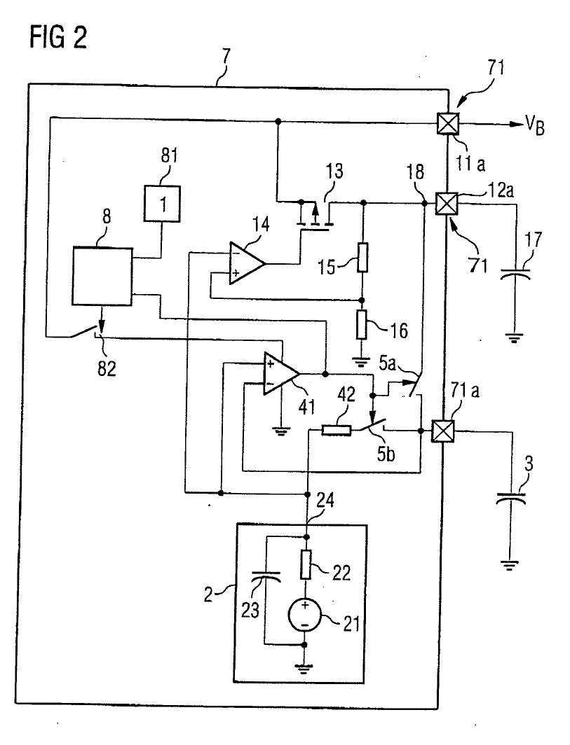

FIG. 2 illustrates a further exemplary embodiment of one or more aspects of the present invention in more detailed form comprising a voltage regulator and a bandgap reference circuit. Components which have the same or similar function as those in FIG. 1 bear the same reference symbols.

In the illustrated example, the voltage regulator and the bandgap reference circuit are produced in one semiconductor body 7. The semiconductor body 7 generally comprises silicon, silicon germanium, gallium arsenide or another semiconductor material. The technology used to produce the individual circuit elements is geared to the respective semiconductor material used. The top of the semiconductor body 7 bears a plurality of contact pads 71. These are usually formed from a thin metal layer with a low resistance and are coupled to the circuit elements within the semiconductor body. The contact pads 71 on the top of the semiconductor body can be supplied with signals or voltages. The contact pads 71 thus simultaneously also form the inputs and outputs of the exemplary arrangement.

An input 11a in the form of a contact pad is provided for supplying a battery voltage VB. The input 11a is routed within the semiconductor body 7 to a connection of a field-effect transistor 13 which is in the form of a regulating transistor for voltage regulation. The second connection of the transistor 13 is connected to the node 18 and to a resistor 15. The node 18 is in turn routed to a contact pad on the surface of the semiconductor body 7 and forms the output 12a. The output 12a is connected to a capacitor 17 outside of the semiconductor body 7. At the same time, the output 12a forms the output of the voltage regulator.

The resistor 15 forms a voltage divider together with the series-connected resistor 16. A tap between the resistors 15 and 16 is routed to a noninverting input of a differential amplifier 14. The output of this differential amplifier 14 is connected to the control connection of the field-effect transistor 13. The field-effect transistor 13 thus represents a controlled path whose voltage drop can be set using the control connection. The voltage divider formed from the resistors 15 and 16, the differential amplifier 14 and the switching transistor 13 together form the voltage regulator.

In addition, the node 18 is connected via a switch 5a to a contact pad 71a on the surface of the semiconductor body 7, to a switch 5b and to the inverting input of a further differential amplifier 41. At the contact pad 71a, a capacitor 3 is connected outside of the semiconductor body 7. The other connection of the switch 5b is connected to a resistor 42. The resistor 42 is in turn connected to the input 24 of the bandgap reference circuit 2. In addition, the resistor 42 is connected to the noninverting input 41 and to the inverting input of the differential amplifier 14 of the voltage regulator.

The bandgap reference circuit 2 comprises a resistor 22 connected to the input 24, a bandgap reference 21 connected in series therewith and a second capacitor 23 connected in parallel with the resistor 22 and with the bandgap reference 21. The capacitance of the second capacitor 23 is significantly smaller than the capacitance of the capacitor 3.

The differential amplifier 41, the resistor 42 and the switches 5a and 5b form the control circuit 4. The differential amplifier 41 also functions as a sensor which ascertains the voltage of the capacitor 3. To activate the entire control circuit 4 and particularly the differential amplifier 41, the latter has its supply input connected to the supply input 11a via a switch 82. The switch 82 can be controlled by a flipflop circuit 8, for example.

The bandgap reference circuit 2 is designed to output a constant voltage signal to the voltage regulator circuit. As a result, the voltage regulator circuit generates a regulated voltage at the output 12a. This is done during operation of the entire circuit by outputting a constant voltage signal at the output 24 of the bandgap reference circuit 2 to the inverting input of the differential amplifier 14. For a constant supply of the bandgap reference voltage, the output 24 is coupled to an RC filter. This RC filter is formed by a series circuit comprising the externally arranged capacitor 3 and the resistor 42. To this end, the capacitor 3 is charged to a desired voltage before operation of the bandgap reference circuit. This voltage generally corresponds to the bandgap voltage generated by the bandgap circuit 2.

During a power-saving operating state, the circuit is isolated from the voltage supply VB. The individual elements of the semiconductor body 7 are accordingly deenergized. At the same time, the switch 5a is closed, and a connection exists from the external capacitor 3 to the output of the voltage regulator 12a. The switch 82 is also closed.

Following an activation command, the supply voltage VB is applied to the supply input 11a. The supply voltage VB thus automatically supplies the differential amplifier 41 of the control circuit. At the same time, the switching transistor 13 in the voltage regulator is closed, which means that the voltage VB is likewise present on the node 18 and applies a charging current both to the capacitor 3 and to the capacitor 17 via the closed switch 5a. This charging current is large since the current-carrying capacity of the transistor 13 is likewise large.

At the same time, the bandgap reference 21 within the bandgap reference circuit 2 is connected to the integrated capacitor 23. Despite the small flow of current through the bandgap reference 21, the capacitor 23 is charged by the bandgap reference 21 very quickly on account of its small capacitance. As a result, the output 24 of the bandgap reference circuit 2 generates a voltage which is sufficient to activate the differential amplifier 14 and hence the voltage regulator circuit.

It will be appreciated that the capacitance of the capacitor 23 can be small, since a high level of noise or a low level of accuracy in the bandgap reference circuit 2 is not significant on account of the small capacitance during the initialization phase of the voltage regulator. It is merely important that the voltage regulator circuit starts operation. Hence, the charging current for the output capacitor 17 and for the capacitor 3 required for the filter flows via the switching transistor 13. Since the voltage regulator is designed to process large currents, the charging process takes place very quickly, particularly for the capacitor 3.

The increasing voltage across the capacitor 3 is measured by the inverting input of the differential amplifier 41 and is compared with the voltage generated by the bandgap reference circuit 2 at the noninverting input. When a particular value is reached, typically the bandgap reference voltage, the differential amplifier 41 generates a signal at its output. This signal opens the switch 5a and thus isolates the capacitor 3 from the node 18 and from the battery supply voltage VB. The capacitor 3 has now been charged to a desired voltage which is sufficient for normal operation of the circuit 2.

At the same time, the switch 5b is closed. The charged capacitor 3 together with the resistor 42 forms an RC filter which now filters noise from the bandgap reference circuit and delivers an accurate and constant voltage value. Leakage current from the capacitor is compensated for by the circuit 2.

As a result of the switch 5b being closed, the bandgap reference circuit 2 starts its normal active operation. Voltage regulation at the output 18 or 12a is now effected by comparing the voltage divided by the voltage divider 15 and 16 and the reference voltage which is output by the bandgap reference circuit 2. The voltage regulator comprising the differential amplifier 14, the switching transistor 13 and the voltage divider is now controlled by the bandgap reference circuit 2 and the RC element comprising the resistor 42 and the capacitor 3.

At the same time as the switch signal is output to the switches 5a and 5b, the flipflop 8 is reset. As a result, the switch 82 opens and isolates the differential amplifier 41 from the supply. The entire control circuit thus has no power consumption during normal active operation of the rest of the switching elements. It is naturally possible to deactivate the voltage supply VB again at any time.

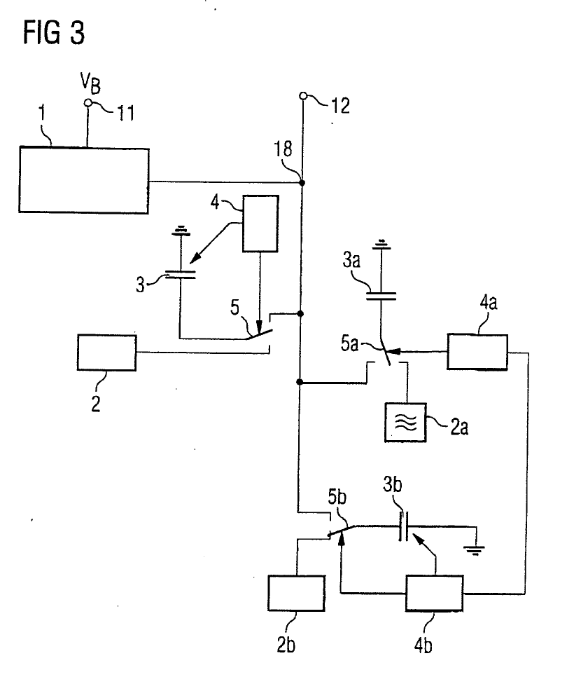

The use of a circuit 1 with a large current-carrying capacity means that it is possible to connect a plurality of capacitors associated with various circuits to the circuit 1 in parallel. An exemplary embodiment is illustrated in FIG. 3 wherein three parallel-connected circuits that require a charged capacitor for their operation are connected to the circuit 1.

In FIG. 3, the voltage regulator 1, whose supply input is connected to the input 11 for supply of a supply voltage VB, is designed in the same way as in FIGS. 1 and 2.

The node 18 is routed to a first switch 5, which couples the capacitance 3 to the node 18. In addition, the switch 5 couples the circuit 2, which is in the form of a bandgap reference, to the capacitor. A control circuit couples the capacitance to the node 18 or to the circuit 2 on the basis of a voltage or on the basis of a quantity of charge stored on the capacitor 3. Hence, this part of the circuit is similar to the exemplary embodiment in FIG. 1.

In addition, the node 18 is also connected to a second switch 5a. In one switch position, this second switch 5a couples the node 18 to a further capacitor 3a. In another switch position, the capacitor 3a is connected to a circuit 2a. This circuit is in the form of an active filter and requires the charged capacitor 3a for operation. The position of switch 5a is set by a time circuit 4a. This circuit is coupled to the voltage regulator 1 and, at the start of the charging process for the capacitor 3a, opens the switch 5a after a prescribed time and connects the capacitor 3a to the circuit 2a.

The time circuit can be in significantly simplified form, since it provides for changeover always after a prescribed time. The time may preferably be adjustable so as to compensate for component variations in the capacitor 3a.

Finally, a third circuit 2b is provided. This circuit is also coupled to a capacitor 3b via a further switch 5b, which, in its other switch position, connects one connection of the capacitor to the node 18. In this case, the control circuit 4b is likewise designed for measuring the charged state of the capacitor. In addition, it is connected to the control unit 4a.

In the exemplary embodiment, the capacitor 3b is coupled to the node 18 when a charging process for the capacitor 3a has concluded, that is to say when the switch 5a connects the capacitor 3a to the rest of the filter circuit 2a. The dependency of the individual charging process allows them to be controlled. An excessive current as a result of simultaneous connection of all three capacitors is avoided. The parallel and independent form makes it possible to charge the capacitors 3 and 3a to various voltages.

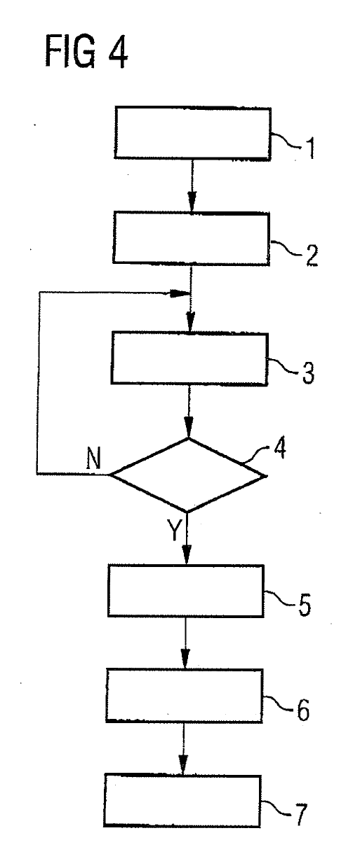

FIG. 4 illustrates a method for initializing circuits within an integrated circuit according to one or more aspects of the present invention. Although the methodology is illustrated and described hereinafter as a series of acts or events, it will be appreciated that the present invention is not limited by the illustrated ordering of such acts or events. For example, some acts may occur in different orders and/or concurrently with other acts or events apart from those illustrated and/or described herein. In addition, not all illustrated steps may be required to implement a methodology in accordance with one or more aspects of the present invention. Further, one or more of the acts may be carried out in one or more separate acts or phases. It will be appreciated that a methodology carried out according to one or more aspects of the present invention may be implemented in association with circuitry illustrated and/or described herein as well as with other circuitry not illustrated or described herein.

In the illustrated example, the circuit is initially in a power-saving operating state in which most of the switching elements are isolated from the voltage supply. At 1, an appropriate command is output to switching elements for the purpose of initialization or for starting an initialization and activation operation.

Next, at 2, charge stores associated with circuits and whose circuits require a charge store to which a charge has been applied for operation are connected to a connection for supplying a large charging current. At 3, this charging current is supplied to the charge stores, and a charge stored on the charge stores. In this way, a voltage drop is also produced across the charge stores. It is expedient for the charging current to be provided by an appropriate circuit. By way of example, this may be a voltage regulator circuit which has a large current-carrying capacity and is designed to supply switching elements with a regulated supply voltage. However, any other charging circuit may also be used for this purpose, provided that it has a larger current-carrying capacity than the circuit with which the charge store is associated during an active operating state.

The charging circuit can be designed, for example, such that it is isolated from further switching elements during the initialization phase in which the charge stores are charged. This prevents these switching elements from receiving an excessive supply voltage or excessive charging currents.

During the charging process, a check is performed at 4 to determine whether the voltage drop across the charge store is sufficient for operating the associated circuit. If this voltage is not sufficient, charge continues to be supplied.

When a sufficient voltage has been achieved for the circuit associated with the capacitor, the charge store is isolated from the supply of the charging current at 5. There is thus now a fixed prescribed charge on the charge store. At 6, the charged charge store is connected to the circuit. At 7, a signal is transmitted to the circuit to enable active operation. Outputting this additional signal prevents the circuit from changing to an undefined operating state. There is thus the assurance that the charge store is already fully connected to the circuit.

It will be appreciated that the features presented here in the individual exemplary embodiments can also be combined. The exemplary method and the arrangements may be used in mobile devices which include a normal active operating mode and a power-saving mode. It is a very frequent occurrence in this case for the initialization phase to have to be performed from the power-saving operating state to the active operating state both for a voltage regulator and for capacitance-based circuits. The inventive idea of using circuits with a large current-carrying capacity instead of the associated circuits during a charging operation for capacitors allows a significant reduction in the charging time and hence in the duration of the initialization phase. The charging behavior of the charge store is thus dependent primarily on the behavior of the current-carrying capacity of the circuit and also the latter's initialization behavior. Once the charge store has been charged to the desired voltage, it is isolated from the circuit which is responsible for the charging process and is connected to the circuit associated with operation.

Although the invention has been illustrated and described with respect to a certain aspect or various aspects, it is obvious that equivalent alterations and modifications will occur to others skilled in the art upon the reading and understanding of this specification and the annexed drawings. In particular regard to the various functions performed by the above described components (e.g., assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several aspects of the invention, such feature may be combined with one or more other features of the other aspects as may be desired and advantageous for any given or particular application. Furthermore, to the extent that the term “includes” is used in either the detailed description or the claims, such term is intended to be inclusive in a manner similar to the term “comprising.” Also, exemplary is merely intended to mean an example, rather than the best.

### LIST OF REFERENCE SYMBOLS

1: Regulator circuit
2, 2a, 2b: Circuit
3, 3a, 3b: Capacitor
4, 4a, 4b: Control circuit
11, 11a: Supply input
13: Regulating transistor
14, 41: Differential amplifier
15, 16: Resistors
5, 5a, 5b: Switch
17: Capacitor
23: Bandgap capacitor
21: Bandgap reference circuit
22: Resistor
8: Flipflop circuit
VS1, VS2, VS3, SA: Signals
V_{B}: Battery supply voltage, supply potential
48: Control output
19 Control input

1. A voltage supply circuit, comprising:
a charge store;
a regulator circuit which has a first operating state and a second operating state, wherein in the second operating state the regulator circuit is designed to output a regulated current or a regulated voltage to an output, where the regulated current is derived from a first supply signal (VB) applied to a supply input;
a circuit which has a first operating state and a second operating state, where, in the second operating state, the circuit is designed to execute electronic signal processing together with the charge store,
where the charge store in the second operating state of the circuit is operatively coupled to the circuit to execute the electronic signal processing of the circuit, and which in the first operating state of the regulator circuit is coupled to the output of the regulator circuit, with the regulator circuit in the first operating state being designed to output a charging current to the charge store; and
a control circuit which comprises a sensor for evaluating a charge state of the charge store and which, when a particular value of the charge state of the charge store is reached, is designed to couple the charge store to the circuit, as a result of which the circuit adopts its second operating state.

2. The voltage supply circuit of claim 1, further comprising:
a switch that is controllable by the control circuit and that is designed for alternatively coupling the charge store to the regulator circuit and the circuit.

3. The voltage supply circuit of claim 2, wherein the control circuit comprises a differential amplifier having a first (−) and a second (+) input, where the first input (−) is coupled to a connection of the charge store, the second input (+) is designed to supply a first reference signal, and an output of the differential amplifier is connected to the switch.

4. The voltage supply circuit of claim 3, wherein the charge state can be represented by a voltage drop across the charge store.

5. The voltage supply circuit of claim 4, wherein the control circuit has a time circuit which is designed to output a switching signal to the switch after a prescribed time.

6. The voltage supply circuit of claim 5, wherein the charge state is represented by a time which has elapsed since the start of the charging current being output.

7. The voltage supply circuit of claim 6, wherein the circuit has an active filter which is formed with the charge store.

8. The voltage supply circuit of claim 7, wherein the circuit is designed to control the regulator circuit to output the regulated voltage in the second operating state of the regulator circuit.

9. The voltage supply circuit of claim 8, wherein the circuit comprises a bandgap reference circuit which is coupled to the charge store and which has an output which is coupled to the regulator circuit.

10. The voltage supply circuit of claim 9, wherein the regulator circuit comprises a differential amplifier having a first input (−), a second input (+) and an output, where the first input (−) is coupled to the circuit and the second input (+) is coupled to the output of the regulator circuit.

11. The voltage supply circuit of claim 10, wherein the second input (+) of the regulator circuit is connected to the output of the regulator circuit via a voltage divider.

12. The voltage supply circuit of claim 11, wherein in the first operating state of the regulator circuit the charge store is coupled to the supply input of the regulator circuit.

13. The voltage supply circuit of claim 12, wherein the regulator circuit and the circuit are in the form of an integrated circuit in a semiconductor body.

14. The voltage supply circuit of claim 13, wherein the charge store is arranged outside of the semiconductor body.

15. The voltage supply circuit of claim 14, wherein the supply input of the regulator circuit is coupled to a contact pad formed on a surface of the semiconductor body.

16. The voltage supply circuit of claim 15, wherein the charge store is connected to a contact pad which is formed on a surface of the semiconductor body and which is coupled to the circuit.

17. The voltage supply circuit of claim 16, wherein the control circuit comprises a signal input for disconnecting the control circuit which is connected to the circuit, and wherein the circuit in the second operating state is designed to output a disconnection signal to the control circuit.

18. The voltage supply circuit of claim 17, wherein the control circuit has an output for outputting a signal to a control input of the circuit, and wherein the circuit is designed to change from the first to the second operating state on the basis of a control signal at the control input.

19. The voltage supply circuit of claim 18, wherein the charge store comprises a capacitor.

20. A voltage supply circuit, comprising:
a charge store;
a charging circuit which in a first operating state is coupled to the charge store and is designed to charge the charge store;
a signal processing circuit which requires the charged charge store for operation and which in a second operating state of the charging circuit is coupled to the charged charge store;
a sensor coupled to the charge store, and designed to put the charging circuit into the first or second operating states.

21. The voltage supply circuit of claim 20, in which the charging circuit in the second operating state is designed to output a supply signal to the signal processing circuit.

22. A method for starting up a circuit arrangement having a charge store to which a charge can be applied for operating the arrangement, the method comprising:
supplying a charging current to the charge store.

23. The method of claim 22, wherein the arrangement comprises:
a voltage regulator having a first current-carrying capacity;
a second arrangement having a second current-carrying capacity, which is below the first current-carrying capacity, with the second arrangement comprising a charge store to which a charge is applied.

24. The method of claim 23, further comprising:
ascertaining a value for a charge state of the charge store;
comparing the value to a reference value;
coupling the charge store to the arrangement based on the comparison.

25. The method of claim 24, further comprising:
coupling the charge store to an output of the voltage regulator; and
outputting a charging current to the output of the voltage regulator.

26. The method of claim 22, wherein the circuit arrangement is implemented in a mobile device which comprises a battery as a power supply.
